(19) United States
(12) Patent Application Publication
(10) Pub. No.: US 2022/0108032 A1
(43) Pub. Date: Apr. 7, 2022

(54) DOCUMENT MANAGEMENT APPARATUS, DOCUMENT MANAGEMENT SYSTEM, AND NON-TRANSITORY COMPUTER READABLE MEDIUM

(71) Applicant: FUJIFILM Business Innovation Corp., Tokyo (JP)

(72) Inventor: Takuya YAMADA, Kanagawa (JP)

(73) Assignee: FUJIFILM Business Innovation Corp., Tokyo (JP)

(21) Appl. No.: 17/307,304

(22) Filed: May 4, 2021

(30) Foreign Application Priority Data
Oct. 1, 2020 (JP) 2020-166763

(51) Int. Cl. G06F 21/62; G06F 16/93

(52) U.S. Cl. CPC G06F 21/6218; G06F 2221/2141; G06F 21/6209; G06F 16/93

(57) ABSTRACT

A document management apparatus includes: a processor configured to: acquire a first term that is contained in a document, the first term being specific to an organization to which a user belongs; acquire second terms of which the user has knowledge, the second terms being specific to the organization; and compare the first term and the second terms so as to control an access right of the user to the document.

### CROSS-REFERENCE TO RELATED APPLICATIONS

This application is based on and claims priority under 35 USC 119 from Japanese Patent Application No. 2020-166763 filed Oct. 1, 2020.

### BACKGROUND

### (i) Technical Field

The present disclosure relates to a document management apparatus, a document management system, and a non-transitory computer readable medium.

### (ii) Related Art

Patent No. 5644977 discloses a document management apparatus including a receiver and a granting unit. The receiver receives a document to which a first user has an access right and an action history of the first user. When a similarity between the action history of the first user and an action history of a second user is equal to or more than a threshold value, the granting unit grants the second user an access right to the document. The granting unit calculates a similarity between an action history of the first user during creation of the document and the action history of the second user during the creation of the document.

### SUMMARY

Aspects of non-limiting embodiments of the present disclosure relate to providing a document management apparatus, a document management system, and a non-transitory computer readable medium that can easily set or change access rights to documents as compared with a case in which an administrator sets or changes an access right for each document.

The term “access right” refers to a right to use a resource managed by a system.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a document management apparatus including: a processor configured to: acquire a first term that is contained in a document, the first term being specific to an organization to which a user belongs; acquire second terms of which the user has knowledge, the second terms being specific to the organization; and compare the first term and the second terms so as to control an access right of the user to the document.

### BRIEF DESCRIPTION OF THE DRAWINGS

Exemplary embodiment(s) of the present disclosure will be described in detail based on the following figures, wherein:

FIG. 1 is a block diagram illustrating a document management system according to exemplary embodiments of the present disclosure;

FIG. 2 is a block diagram illustrating hardware of a document management apparatus used in the exemplary embodiments of the present disclosure;

FIG. 3 is a flowchart of an operation of a document management apparatus according to a first exemplary embodiment of the present disclosure;

FIG. 4 is a diagram illustrating an operation flow of the document management apparatus according to the first exemplary embodiment of the present disclosure;

FIG. 5 is a flowchart of an operation of a document management apparatus according to a second exemplary embodiment of the present disclosure;

FIG. 6 is a diagram illustrating contents of a knowledge database in the document management system according to the second exemplary embodiment of the present disclosure;

FIG. 7 is a diagram illustrating a manner in which an access right of each user is changed in the document management system according to the second exemplary embodiment of the present disclosure;

FIG. 8 is a flowchart of an operation of a document management apparatus according to a third exemplary embodiment of the present disclosure;

FIG. 9A illustrates a document 1 before and after update in a document management system according to the third exemplary embodiment of the present disclosure;

FIG. 9B illustrates in-house proper nouns contained in the document 1 before and after the update in the document management system according to the third exemplary embodiment of the present disclosure;

FIG. 9C illustrates access rights of users before and after the update in the document management system according to the third exemplary embodiment of the present disclosure;

and

FIG. 10 is a diagram illustrating contents of a knowledge database in the document management system according to the third exemplary embodiment of the present disclosure.

### DETAILED DESCRIPTION

Next, exemplary embodiments of the present disclosure will be described with reference to the accompanying drawings.

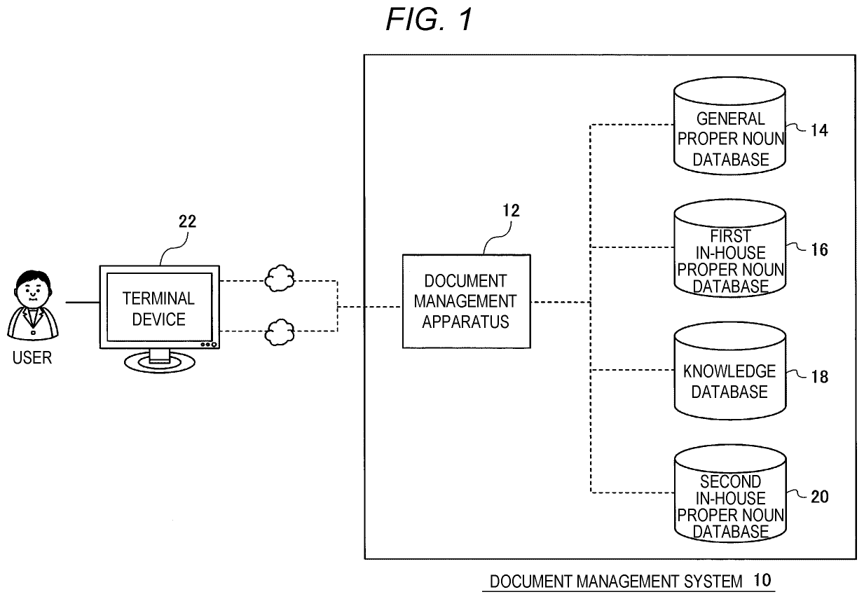

FIG. 1 illustrates the entirety of a document management system 10 according to exemplary embodiments of the present disclosure. The document management system 10 manages documents of a company that is one of organizations.

The document management system 10 includes a document management apparatus 12, for example, implemented by a server. The document management apparatus 12 is connected to a general proper noun database 14, a first in-house proper noun database 16, a knowledge database 18, and a second in-house proper noun database 20. The document management apparatus 12 manages access rights to documents based on data registered in the databases 14, 16, 18, and 20.

The general proper noun database 14 is a general dictionary such as a Japanese-Japanese Dictionary, a Japanese-English Dictionary, an English-English dictionary, and an English-Japanese dictionary. The in-house proper noun database 16 is a dictionary that manages in-house jargon. For example, an administrator manually registers terms (for example, in-house jargon) in the first in-house proper noun database 16 in advance. The knowledge database 18 is a database that manages, for the user, in-house proper nouns that are likely to be known to the user. The in-house proper nouns that are likely to be known to each user include, for example, a term contained in a document prepared by the user, a term used in a group to which the user belongs, and a term with which the user has performed a search. The second in-house proper noun database 20 is a database that manages in-house proper nouns contained in each document in association with the document.

The document management apparatus 12 is connected to a terminal device 22 via a network such as an in-house local area network (LAN) or the Internet. The terminal device 22 is, for example, a personal computer. The user operates the terminal device 22 and searches for a document to display the document on the terminal device 22.

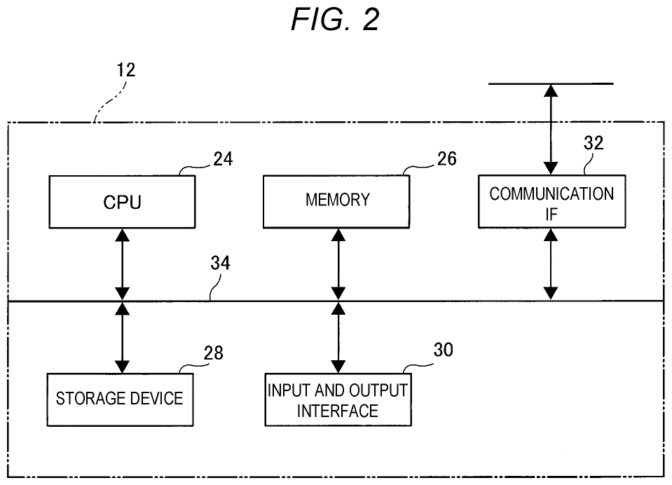

FIG. 2 is a block diagram illustrating hardware of the document management apparatus 12.

The document management apparatus 12 includes a CPU 24 (an example of a processor), a memory 26, a storage device 28, an input and output interface 30, and a communication interface 32. The CPU 24, the memory 26, the storage device 28, the input and output interface 30, and the communication interface 32 are connected to each other via a bus 34.

The CPU 24 executes a predetermined process based on a control program stored in the memory 26. The storage device 28 is implemented by, for example, a hard disk, and stores necessary software and data. The communication interface 32 is connected to the network and inputs and outputs data through the network.

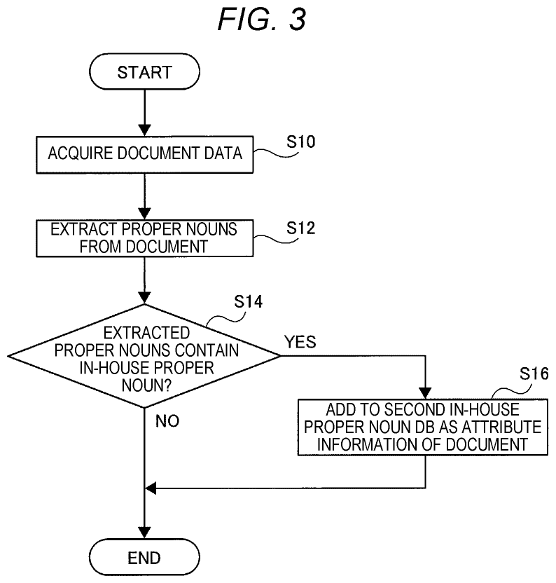

FIG. 3 illustrates a flowchart according to a first exemplary embodiment. The first exemplary embodiment is a flow up to registration of a document.

In a step S10, document data is acquired. Here, the document data mainly includes text data, but may include figures, images, videos, and audio. Examples of the document include a document created in a company (that is, an in-house document), and a document that is acquired from outside of the company.

In a next step S12, a syntactic analysis is performed for the document based on the document data acquired in the step S10 to extract proper nouns. Examples of the proper noun include a general proper noun and an in-house proper noun.

In a next step S14, it is determined whether the proper nouns extracted in the step S12 contain an in-house proper noun. Whether the proper nouns extracted in the step S12 contain an in-house proper noun is determined by searching the first in-house proper noun database 16 to determine if an in-house proper noun that matches any of the extracted proper nouns is found. If it is determined in the step S14 that the proper nouns extracted in the step S12 contain an in-house proper noun, a process proceeds to step S16 and additionally registers the in-house proper noun, which is found in the step S14, in the second in-house proper noun database 20 as attribute information of the document. In other words, the process registers the in-house proper noun in the second in-house proper noun database 20 in association with the document, and then ends. On the other hand, if it is determined in the step S14 that the document contains no in-house proper noun, the process ends as it is.

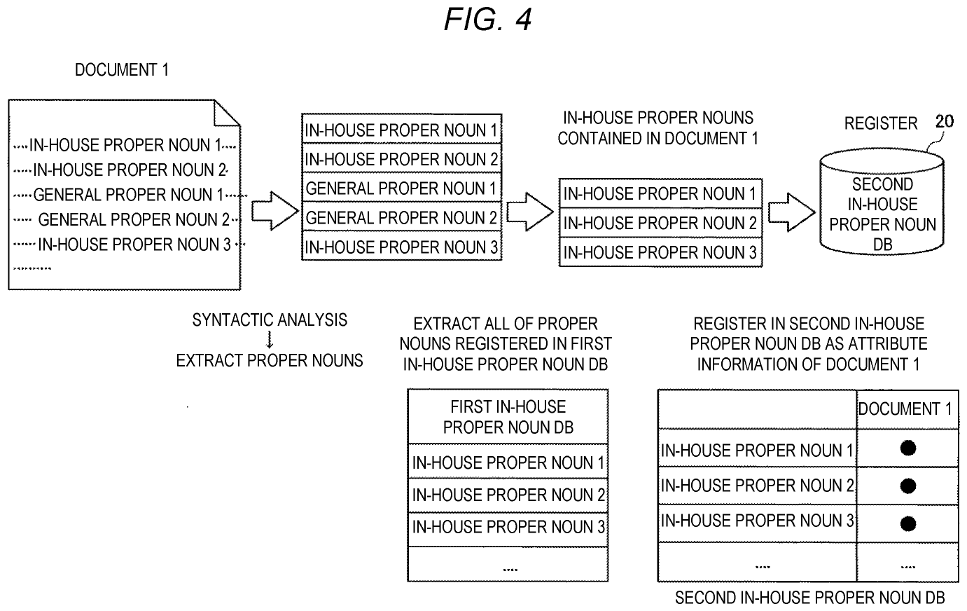

FIG. 4 illustrates a specific example of the first exemplary embodiment.

It is assumed that a document 1 contains in-house proper nouns 1, 2, and 3, and general proper nouns 1 and 2. As described in the step S10, the document 1 is acquired as text data. Next, as described in the step S12, the syntactic analysis is performed for the document 1, to extract the in-house proper nouns 1, 2, and 3 and the general proper nouns 1 and 2 as proper nouns. Then, the first in-house proper noun database 16 is searched as described in the step S14. The in-house proper nouns 1, 2, and 3 have been registered in the first in-house proper noun databases 16. As results of the search, the in-house proper nouns 1, 2, and 3 are extracted and are additionally registered in the second in-house proper noun database 20 in association with the document 1 as described in the step S16. In other words, the in-house proper nouns 1, 2, and 3 are registered in the second in-house proper noun database 20 in association with the document 1.

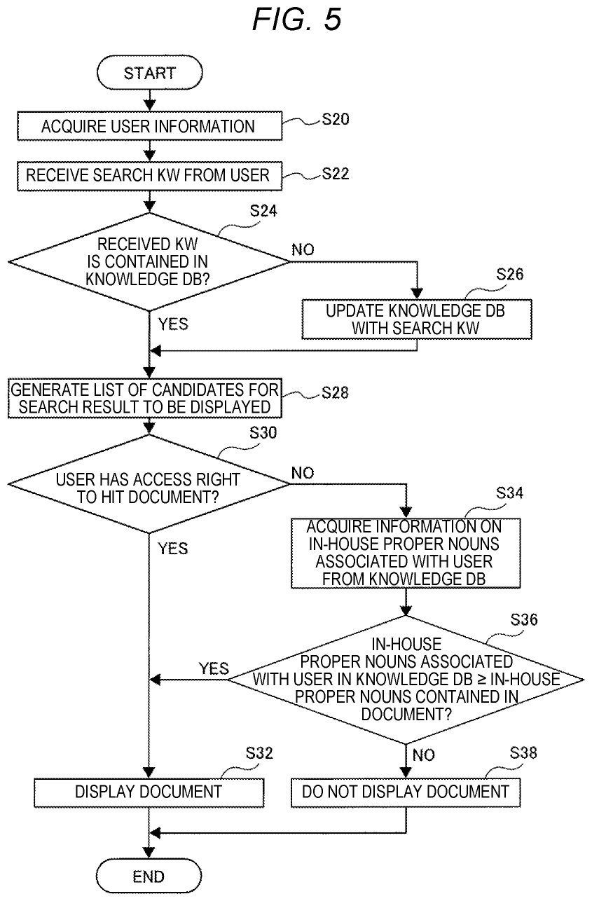

FIG. 5 illustrates a flowchart according to a second exemplary embodiment. The second exemplary embodiment is a flow of a document search by a user.

First, in a step S20, user information is acquired. The user information includes, for example, (i) a user ID of a user who has logged in the document management system 10 from the terminal device 22 and (ii) a password of the user.

In a next step S22, a search keyword (KW) input by the user is received. In the next step S24, it is determined whether the keyword received in the step S22 has been registered in the knowledge database 18 in association with the user indicated by the user information acquired in the step S20. If it is determined in the step S24 that the keyword has not been registered in the knowledge database 18 in association with the user indicated by the user information, the process proceeds to a step S26 and updates the knowledge database 18 such that the keyword is registered therein in association with the user indicated by the user information. On the other hand, if it is determined in the step S24 that the keyword has been registered in the knowledge database 18 in association with the user indicated by the user information, the process proceeds to a next step S28.

In the step S28, a list of candidates of a search result to be displayed is generated based on the keyword received in step S22.

In a next step S30, it is determined whether the user indicated by the user information has an access right to the document hit in the step S28. If it is determined in the step S30 that the user indicated by the user information has the access right to the document, a process proceeds to step S32, displays the document on the terminal device 22 of the user indicated by the user information, and ends. On the other hand, if it is determined in the step S30 that the user indicated by the user information does not have the access right to the document, the process proceeds to a next step S34.

In the step S34, information on in-house proper nouns associated with the user indicated by the user information are acquired from the knowledge database 18. In a next step S36, it is determined whether the in-house proper nouns acquired in the step S34 include all of the in-house proper nouns which are contained in the document.

If it is determined in the step S36 that the in-house proper nouns acquired in the step S34 include all of the in-house proper nouns contained in the document, the process proceeds to the step S32, displays the document on the terminal device 22 of the user indicated by the user information, and ends. On the other hand, if it is determined in step S36 that the in-house proper nouns acquired in the step S34 do not include all of the in-house proper nouns contained in the document, the process proceeds to a step S38, and ends without displaying the document.

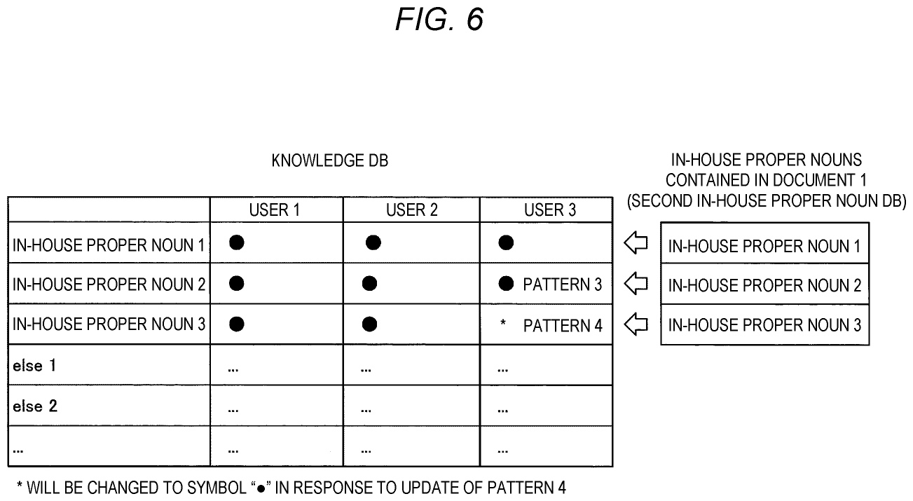

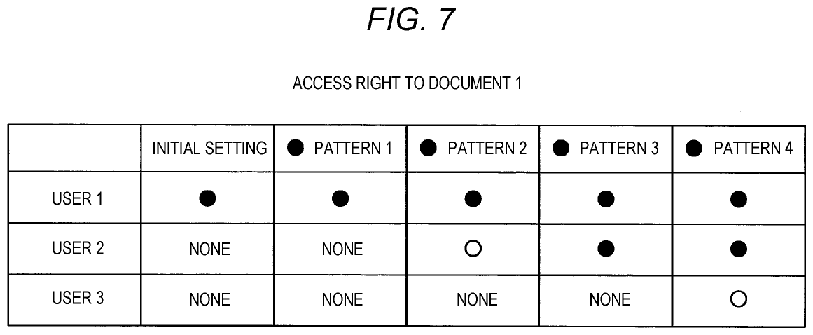

FIGS. 6 and 7 illustrate a specific example of the second exemplary embodiment.

In FIG. 6, a symbol “•” indicates that a user (specifically, users 1, 2, or 3) has knowledge of a corresponding in-house proper noun. For example, the user 1 has been registered as having knowledge of the in-house proper nouns 1, 2, and 3. When a pattern 2 is executed, the user 2 is registered as having knowledge of the in-house proper nouns 1 in addition to the in-house proper nouns 2 and 3. The user 3 has been registered as having knowledge of the in-house proper nouns 1. When a pattern 3 is executed, the user 3 is registered as having knowledge of the in-house proper nouns 2. When a pattern 4 is executed, the user 3 is registered as having knowledge of the in-house proper noun 3. It is assumed that the document 1 contains the in-house proper nouns 1, 2, and 3. FIG. 7 illustrates a manner in which access rights are updated when the pattern 1, 2, 3, and 4 are executed in order. The symbol “•” indicates that a user already has an access right to the document 1. A symbol “o” indicates that a user does not originally have the access right to the document 1, but get the access right by inputting a keyword.

The pattern 1 is a case in which the user 1 performs a search using the in-house proper noun 1 as the keyword. In this case, since the access right has already been set to the user 1 by an initial setting, the determination result in the step S30 is yes, the process proceeds to the step S32, and the document 1 is displayed.

The pattern 2 is a case in which the user 2 performs a search using the in-house proper noun 1 as the keyword. In the original state, the in-house proper noun 1 is not registered in the knowledge database 18 in association with the user 2. Thus, the user 2 does not originally have the access right to the document 1. Then, the user 2 performs a search using the in-house proper noun 1 as the keyword, which means that the user 2 has knowledge of the in-house proper noun 1. Thus, the knowledge database 18 is updated in the step S26 such that the in-house proper noun 1 is registered in association with the user 2. At this time, all of the in-house proper nouns 1, 2, and 3, which are contained in the document 1, have been registered in the knowledge database 18 in association with the user 2, so that the access right is granted to the user 2, and the document 1 is displayed on the terminal device 22 of the user 2 as a search result.

The pattern 3 is a case in which the user 3 performs a search using the in-house proper noun 2 as the keyword. In the initial state, the in-house proper noun 1 is registered in the knowledge database 18 in association with the user 3. Then, the user 3 performs a search using the in-house proper noun 2 as the keyword, so that the in-house proper noun 2 is registered in the knowledge database 18 in association with the user 3. At this time, however, the in-house proper noun 3 has not been registered in the knowledge database 18 in association with the user 3. Accordingly, the condition in the step S36 that all of the in-house proper nouns 1, 2, and 3, which are contained in the document 1, have been registered in the knowledge database 18 in association with the user 3 is not met. The access right to the document 1 is not granted to the user 3, and the document 1 is not displayed on the terminal device 22 of the user 3.

The pattern 4 is a case in which the user 3 performs a search using the in-house proper noun 3 as the keyword. The in-house proper nouns 1 and 2 have been registered in the knowledge database 18 in association with the user 3. The user 3 inputs the in-house proper noun 3 as the keyword. Thus, the knowledge database 18 is updated such that the in-house proper nouns 1, 2, and 3 are registered therein in association with the user 3. The condition in the step S36 that all of the in-house proper nouns contained in the document 1 have been registered is met. Accordingly, the access right to the document 1 is granted to the user 3, and the document 1 is displayed on the terminal device 22 of the user 3.

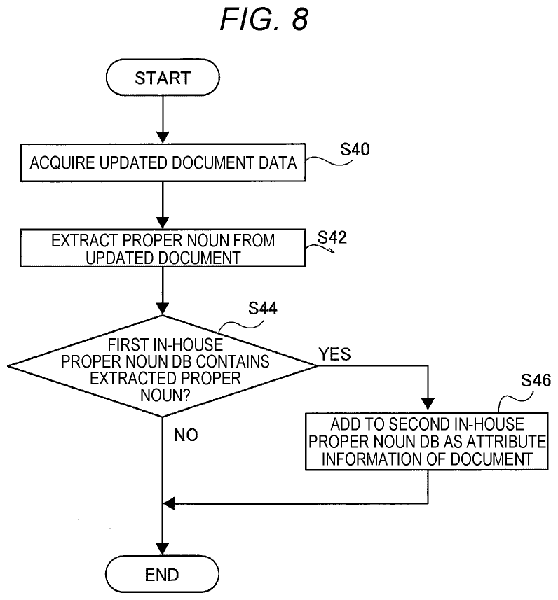

FIG. 8 illustrates a flowchart according to a third exemplary embodiment. The third exemplary embodiment is a flow in a case in which a document is updated.

First, in a step S40, data of an updated document is acquired. In a next step S42, proper nouns are extracted from an updated part of the document. The proper nouns may be extracted from the updated part of the document and added to the proper nouns which have been acquired before the update. Alternatively, a difference between the document before the update and the document after the update may be detected, and the proper nouns may be extracted from the difference.

In a next step S44, it is determined whether the proper nouns extracted in the step S42 contain an in-house proper noun. If it is determined in the step S44 that the proper nouns extracted in the step S42 contain an in-house proper noun, a process proceeds to a step S46 and additionally registers the in-house proper noun, which is found in the step S44, in the second in-house proper noun database 20 as attribute information of the document, and the process ends. On the other hand, if it is determined in the step S44 that the document contains no in-house proper noun, the process ends as it is.

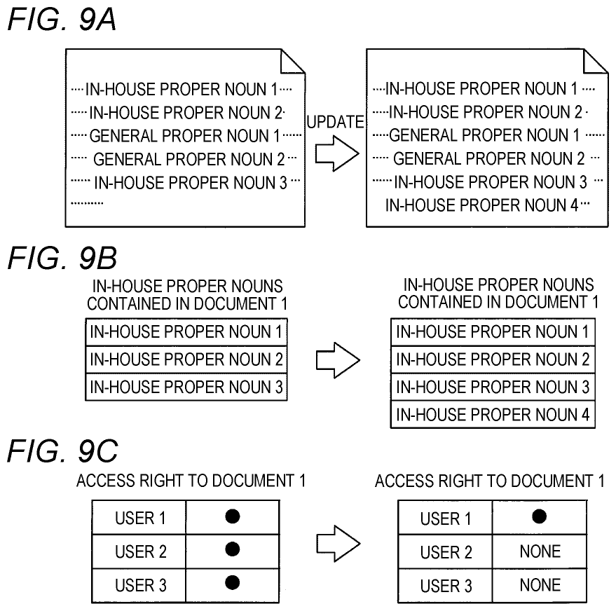

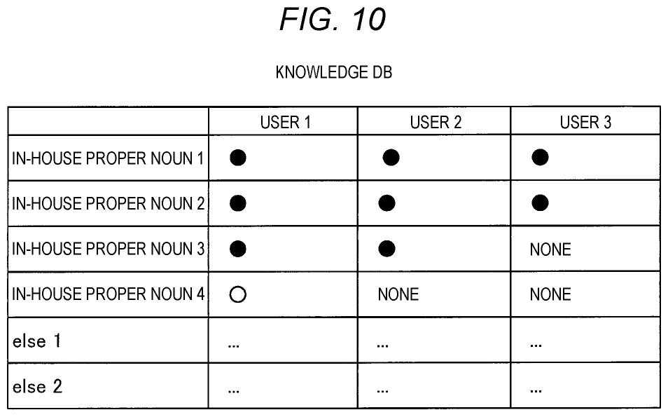

FIGS. 9 and 10 illustrate a specific example of the third exemplary embodiment.

It is assumed that the document 1 has been updated by a user X as illustrated in FIG. 9A. This update has added an in-house proper noun 4. As illustrated in FIG. 9B, while the in-house proper nouns 1, 2, and 3 were registered in the second in-house proper noun database 20 before the update, the in-house proper noun 4 has been added through the update. As illustrated in FIG. 10, the in-house proper noun 4 has been additionally registered in the knowledge database 18 in association with the user 1, and the user 1 has knowledge of the in-house proper nouns 1 to 4 contained in the document 1. Accordingly, an access right is granted to the user 1 as indicated by the symbol “o”. Meanwhile, neither the user 2 nor the user 3 has knowledge of the in-house proper noun 4. Thus, as illustrated in FIG. 9C, while the access rights were granted to the users 1 to 3 before the document 1 was updated, the access rights has been removed from the users 2 and 3.

Before the document 1 is updated, for example, an administrator may manually register the in-house proper noun 4 in the knowledge database 18 in association with the user 1. The in-house proper noun 4 may be registered in the knowledge database 18 as knowledge of the user 1 (that is, in association with the user 1), for example, if the user 1 belongs to the same department as the user X who has updated the document 1 or if the user 1 participates in a conference using the updated document 1.

In the exemplary embodiments, the document management system of the company which is one of the organizations has been described. It is noted that the organizations are not limited to the company. Examples of the organizations include an educational institution, a research institute, an association, and a union.

In the exemplary embodiments above, the term “processor” refers to hardware in a broad sense. Examples of the processor include general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the exemplary embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A document management apparatus comprising:
a processor configured to:
acquire a first term that is contained in a document, the first term being specific to an organization to which a user belongs;
acquire second terms of which the user has knowledge, the second terms being specific to the organization; and
compare the first term and the second terms so as to control an access right of the user to the document.

2. The document management apparatus according to claim 1, wherein
the processor is configured to, when the second terms include the first term, perform control so as to grant the user the access right to the document.

3. The document management apparatus according to claim 2, wherein
the processor is configured to, when the second terms include all of a plurality of the first terms, perform control so as to grant the user the access right to the document.

4. The document management apparatus according to claim 1, wherein
the processor is configured to, when the second terms does not include the first term, to perform control so as not to grant the user the access right to the document.

5. The document management apparatus according to claim 4, wherein
the processor is configured to, when the second terms does not include at least one of a plurality of the first terms, to perform control so as not to grant the user the access right to the document.

6. The document management apparatus according to claim 1, wherein
the processor is configured to, when a term specific to the organization is added to the document to update the document, compare the first terms including the added term and the second terms so as to control the access right of the user to the document.

7. A document management system comprising:
a storage configured to store, for each document, a first term that is specific to an organization to which a user belongs; and
a document management apparatus configured to manage an access right to each document, the document management apparatus comprising a processor, wherein
the processors is configured to:
acquire the first terms from the storage;
acquire second terms of which the user has knowledge, the second terms being specific to the organization; and
compare the first term contained in each document and the second terms so as to control an access right of the user to the document.

8. A document management system comprising:
a storage configured to store, for each user, second terms of which the user has knowledge, the second terms being specific to an organization to which the users belong; and
a document management apparatus configured to manage an access right to a document, the document management apparatus comprising a processor, wherein
the processors is configured to:
acquire a first term that is contained in the document, the first term being specific to the organization;
acquire the second terms of which one of the users has the knowledge, from the storage; and
compare the first term and the second terms of which the one of the users has the knowledge so as to control the access right of the user to the document.

9. The document management system according to claim 8, wherein
the processor is configured to
acquire, in addition to the second terms stored in the storage, a term that is specific to the organization and that the one of the users inputs.

10. A document management system comprising:
a first storage configured to store, for each document, a first term that is specific to an organization to which users belong;
a second storage configured to store, for each user, second terms of which the user has knowledge, the second terms being specific to the organization; and
a document management apparatus configured to manage an access right to each document, the document management apparatus comprising a processor, wherein
the processors is configured to:
acquire the first terms from the first storage;
acquire the second terms of which one of the users has the knowledge, from the second storage; and
compare the first term contained in each document and the second terms of which the one of the users has the knowledge, so as to control the access right of the one of the users to the document.

11. A non-transitory computer readable medium storing a program that causes a computer to execute a document management process, the document management process comprising:
acquiring a first term that is contained in a document, the first term being specific to an organization to which a user belongs;
acquiring second terms of which the user has knowledge, the second terms being specific to the organization; and
comparing the first term and the second terms so as to control an access right of the user to the document.
